(19) United States
(12) Patent Application Publication
(10) Pub. No.: US 2015/0025859 A1
(43) Pub. Date: Jan. 22, 2015

(54) COMPUTER-IMPLEMENTED METHOD FOR PERFORMING SIMULATION

(71) Applicants: Kumar K. Tamma, New Brighton, MN (US); Masao Shimada, Minneapolis, MN (US); Siti Ujila Binti Masuri, Negeri Sembilan (MY); Xiangmin Zhou, Wilmette, IL (US)

(72) Inventors: Kumar K. Tamma, New Brighton, MN (US); Masao Shimada, Minneapolis, MN (US); Siti Ujila Binti Masuri, Negeri Sembilan (MY); Xiangmin Zhou, Wilmette, IL (US)

(21) Appl. No.: 14/314,925

(22) Filed: Jun. 25, 2014

Related U.S. Application Data
(60) Provisional application No. 61/841,018, filed on Jun. 28, 2013.

(51) Int. Cl. G06F 17/50; G06F 17/10

(52) U.S. Cl. CPC G06F 17/5009; G06F 17/10
USPC 703/2

(57) ABSTRACT

A computer-implemented method for performing simulation includes establishing a mesh of a physical domain with nodes. The nodes represent a discretized physical quantity. The method accesses one or more different algorithms for evolving the nodes through sequential time steps. The method determines a unique combination of parameter values for each algorithm. In some examples, the parameter values can control dissipation, dispersion, and overshoot for each algorithm, as well as whether each algorithm is implicit or explicit. In some examples, the method can select one or more subsets of the nodes, and/or identify one or more time increments. The method can evolve the nodes in time, optionally using different time increments for different nodes in the mesh, and/or optionally using different algorithms for different nodes in the mesh. The method can optionally identify if an algorithm has failed to converge to a solution, and can switch to a different algorithm.

### CROSS-REFERENCE TO RELATED APPLICATION

This application claims the benefit of U.S. Provisional Application No. 61/841,018, filed Jun. 28, 2013, which is incorporated herein by reference in its entirety.

### BACKGROUND

Many applications use computer simulation to predict behavior. For instance, many systems evolve in time from one or more initial conditions to one or more final conditions through time increments. Some of these time-evolving systems can use a mesh of a physical domain with nodes to represent a discretized physical quantity, and can use an algorithm to evolve the mesh nodes from an initial time to a final time.

### OVERVIEW

A computer-implemented method for performing simulation includes establishing a mesh of a physical domain with nodes. The nodes represent a discretized physical quantity. The method accesses one or more different algorithms for evolving the nodes through sequential time steps. The method determines a unique combination of parameter values for each algorithm. In some examples, the parameter values can control dissipation, dispersion, and overshoot for each algorithm, as well as whether each algorithm is implicit or explicit. In some examples, the method can select one or more subsets of the nodes, and/or identify one or more time increments. The method can evolve the nodes in time, optionally using different time increments for different nodes in the mesh, and/or optionally using different algorithms for different nodes in the mesh. The method can optionally identify if an algorithm has failed to converge to a solution, and can switch to a different algorithm.

### BRIEF DESCRIPTION OF THE DRAWINGS

In the drawings, which are not necessarily drawn to scale, like numerals describe similar components in different views. The drawings illustrate generally, by way of example, but not by way of limitation, various embodiments discussed in the present patent document.

FIG. 1 is a flow chart showing an example of a computer-implemented method for performing simulation.

FIG. 2 is a flow chart showing another example of a computer-implemented method for performing simulation.

FIG. 3 is a flow chart showing another example of a computer-implemented method for performing simulation.

FIG. 4 is a flow chart showing another example of a computer-implemented method for performing simulation.

FIG. 5 is a flow chart showing an example of an initial portion of a framework for first order and second order time-evolving mathematical models.

FIG. 6 is a flow chart showing an example of a further portion of the framework for first order and second order time-evolving mathematical models.

FIG. 7 is a flow chart showing an example of adapting a second order time-evolving mathematical model to a first order time-evolving mathematical model.

FIG. 8 shows details of the GS4-2 family of algorithms from the example of FIG. 7.

FIG. 9 shows details of the GS4-2 U0 family of algorithms from the example of FIG. 7.

FIG. 10 shows details of the GS4-2 V0 family of algorithms from the example of FIG. 7.

FIG. 11 shows details of the GS4-1 family of algorithms from the example of FIG. 7.

FIG. 12 shows details of the GS4-1 family of algorithms, without a selective control feature, from the example of FIG. 7.

FIG. 13 shows details of the GS4-1 family of algorithms, with and without a selective control feature, from the example of FIG. 7.

FIG. 14 shows examples of relationships between the U0 and V0 families of algorithms, from the example of FIG. 7.

FIG. 15 shows details of the U0V0 family of algorithms, from the example of FIG. 7.

FIG. 16 shows examples of relationships among the U0, V0, and U0V0 families of algorithms, from the example of FIG. 7.

FIG. 17 shows details of the GS4 family of algorithms for second-order differential algebraic equations (DAEs).

FIG. 18 is a flow chart showing another example of adapting a second order time-evolving mathematical model to a first order time-evolving mathematical model.

FIG. 19 is a table of algorithms from the GS4-2 U0 family of algorithms.

FIG. 20 is a table of algorithms from the GS4-2 V0 family of algorithms

FIG. 21 is a table of algorithms from the GS4-1 family of algorithms.

### DETAILED DESCRIPTION

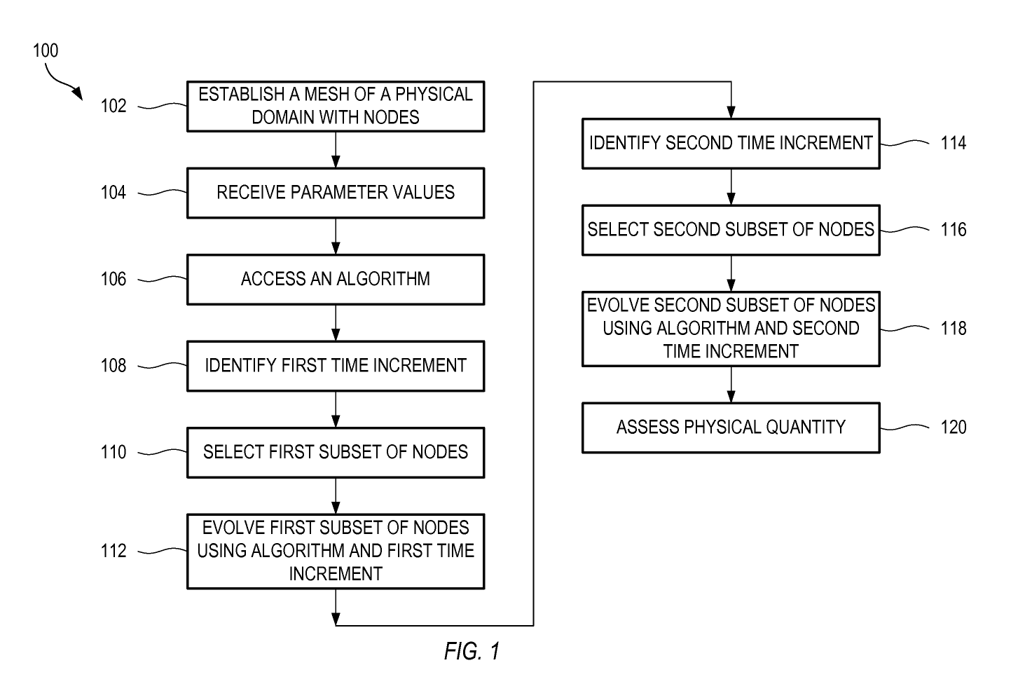

FIG. 1 is a flow chart showing an example of a computer-implemented method 100 for performing simulation. Such a method is capable of time-evolving different nodes of a mesh using different time increments. The computer-implemented method of FIG. 1 is but one example; other examples can also be used.

At 102, method 100 establishes a mesh of a physical domain with nodes. The nodes represent a discretized physical quantity. For instance, the mesh can represent pressure, as a function of three-dimensional space surrounding a structure, such as an airplane. The nodes of the mesh can represent values of pressure, as a function of three-dimensional location within the mesh. The nodes of the mesh can be scalar quantities, such as pressure, or vector quantities, such as velocity. In general, the nodes can represent any suitable quantity that varies over a one-dimensional line, a two-dimensional area, or a three-dimensional volume. The nodes can represent the quantity directly, or can represent a scaled or transformed version of the quantity. The nodes can be vector quantities, or can be one dimensional scalar components of vector quantities. The nodes can also represent combination of more than one physical quantity, such as a product of mass density and an x, y, or z-component of velocity. At 104, method 100 receives a combination of parameter values. The parameter values can be input from a user, read from a stored file, or determined dynamically by an algorithm or a processor running the algorithm. In some examples, the parameter values include values that control a dissipation, a dispersion, and an overshoot for a particular algorithm. In some examples, the parameter values include values for ρₘₐₓ, ρₘᵢₙ, and ρₛₚᵤᵣᵢₒᵤₛ, where the values of ρₘₐₓ, ρₘᵢₙ, and ρₛₚᵤᵣᵢₒᵤₛ control the dissipation, the dispersion, and the overshoot for the particular algorithm. In some examples, the parameter values further include values that control whether a particular algorithm is implicit or explicit. In some examples the parameter values include values for η₁, η₂, and η₃, where the values of η₁, η₂, and η₃ control whether the particular algorithm is implicit or explicit. In some examples, each algorithm can be identified as a unique combination of values of ρₘₐₓ, ρₘᵢₙ, ρₛₚᵤᵣᵢₒᵤₛ, η₁, η₂, and η₃. The Appendix describes in detail how to determine values of ρₘₐₓ, ρₘᵢₙ, ρₛₚᵤᵣᵢₒᵤₛ, η₁, η₂, and η₃ for a given algorithm.

At 106, method 100 accesses an algorithm for the combination of parameter values, for evolving the nodes through sequential time steps. The algorithm receives as input a value at an initial time, and based on a governing equation, produces an iterated value at a subsequent time. The algorithm can be used repeatedly, from an initial time to a final time through time increments, to produce final values for the nodes. The algorithm can converge to a solution. The algorithm can have an efficiency, which can describe how quickly or slowly the algorithm converges to the solution. The time steps can relate to actual time, or can simply be iteration steps that do not relate to actual time. The governing equation can be a differential algebraic equation, a first-order differential equation or a second-order differential equation. In some examples, the final values can be steady-state values, which would not change significantly if the algorithm were applied repeatedly after the final time.

At 108, method 100 identifies a first time increment for the combination of parameter values. The time increment represents the length of time between iterations in the algorithm. Reducing the time increment reduces the length of time between iterations, and can increase a number of iterations between a fixed initial time and a fixed final time.

At 110, method 100 selects a first subset of the nodes for the combination of parameter values. The subset can be greater than or equal to one, but fewer than all of the nodes in the mesh.

At 112, method 100 evolves the first subset of the nodes using the algorithm, from an initial time to a final time, using the first time increment.

At 114, method 100 identifies a second time increment, different from the first time increment, for the combination of parameter values. The parameter values can be input from a user, read from a stored file, or determined dynamically by the algorithm or a processor running the algorithm.

At 116, method 100 selects a second subset of the nodes, different from the first subset, for the combination of parameter values.

At 118, method evolves the second subset of the nodes using the algorithm, from the initial time to the final time, using the second time increment.

At 120, method 100 assesses the physical quantity based on the first subset of the nodes from the initial time to the final time and the second subset of the nodes from the initial time to the final time. For example, a user or a processor can compare the physical quantity to specification or thresholds for a particular design. As another example, a user or a processor can collate values of the physical quantity for use in subsequent processing. Other suitable assessments can also be used.

In some examples, the algorithm includes at least one physical parameter. The algorithm can be a function of the at least one physical parameter and the respective time increment. In some examples, method 100 can further include determining a first time offset for the combination of parameter values. The first time offset can be between zero and the first time increment, inclusive or exclusive. In some examples, method 100 can further include evaluating at least one physical parameter, of the algorithm, between successive evaluations of the first subset of the nodes. The evaluation of the at least one physical parameter and the evaluation of the corresponding node can be offset by the first time offset.

In other words, in some examples, the physical parameters are evaluated periodically for each time increment, and the nodes are also evaluated periodically for each time increment, but the times at which the physical parameters and the nodes are evaluated are offset or staggered with respect to one another. The time offset can be between zero and the respective time increment, inclusive or exclusive.

Each physical parameter can correspond to a term in an evolution equation in the algorithm. The evolution equation can be one of a linear time-varying differential equation, a non-linear time-varying differential equation, a first order differential equation, a second order differential equation, a linear differential algebraic equation, a non-linear differential algebraic equation, a first order differential algebraic equation, or a second order differential algebraic equation. The algorithm can use a numerical method that includes at least one of a finite element method, a finite difference method, a finite volume method, a meshless method, a meshfree method, a boundary element method, a spectral method, a lattice Boltzmann method, or another suitable numerical method.

As a result of method 100, and in particular nodes 110-118, different nodes of a mesh can be time-evolved using different time increments, which can be advantageous in some examples.

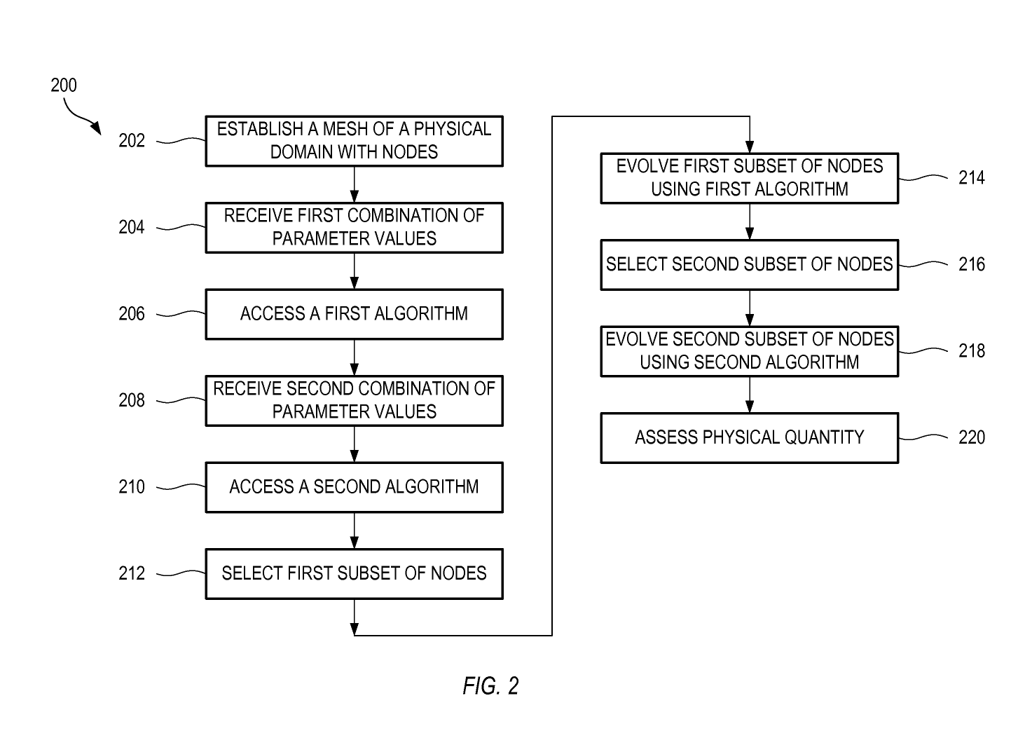

FIG. 2 is a flow chart showing another example of a computer-implemented method 200 for performing simulation. Such a method is capable of time-evolving different nodes of a mesh using different algorithms. The computer-implemented method of FIG. 2 is but one example; other examples can also be used.

At 202, method 200 establishes a mesh of a physical domain with nodes. The nodes represent a discretized physical quantity.

At 204, method 200 receives a first combination of parameter values. The parameter values can be input from a user, read from a stored file, or determined dynamically by an algorithm or a processor running the algorithm. In some examples, the parameter values include values that control a dissipation, a dispersion, and an overshoot for a particular algorithm. In some examples, the parameter values include values for ρₘₐₓ, ρₘᵢₙ, and ρₛₚᵤᵣᵢₒᵤₛ, where the values of ρₘₐₓ, ρₘᵢₙ, and ρₛₚᵤᵣᵢₒᵤₛ control the dissipation, the dispersion, and the overshoot for the particular algorithm. In some examples, the parameter values further include values that control whether a particular algorithm is implicit or explicit. In some examples the parameter values include values for η₁, η₂, and η₃, where the values of η₁, η₂, and η₃ control whether a particular algorithm is implicit or explicit. In some examples, each algorithm can be identified as a unique combination of values of ρₘₐₓ, ρₘᵢₙ, ρₛₚᵤᵣᵢₒᵤₛ, η₁, η₂, and η₃. The Appendix describes in detail how to determine values of ρₘₐₓ, ρₘᵢₙ, ρₛₚᵤᵣᵢₒᵤₛ, η₁, η₂, and η₃ for a given algorithm.

At 206, method 200 accesses a first algorithm for evolving the nodes for the first combination of parameter values, through sequential time steps.

At 208, method 200 receives a second combination of parameter values, different from the first combination of parameter values. The parameter values can be input from a user, read from a stored file, or determined dynamically by the algorithm or a processor running the algorithm. The first and second combinations differ in at least one parameter value, and optionally, differ in more than one parameter value.

At 210, method 200 accesses a second algorithm, different from the first algorithm, for the second combination of parameter values, for evolving the nodes through sequential time steps.

At 212, method 200 selects a first subset of the nodes for the first and second combinations of parameter values.

At 214, method 200 evolves the first subset of the nodes, using the first algorithm, from an initial time to a final time.

At 216, method 200 selects a second subset of the nodes, different from the first subset, for the first and second combinations of parameter values.

At 218, method 200 evolves the second subset of the nodes using the second algorithm, from the initial time to the final time. In some examples, the method 200 evolves the first and second subsets of nodes with the same time increment. In other examples, the method 200 evolves the first and second subsets of nodes with different time increments.

At 220, method 200 assesses the physical quantity, based on the first subset of the nodes at the final time and the second subset of the nodes at the final time.

In some examples, the first algorithm can include at least one physical parameter. The first algorithm can be a function of the at least one physical parameter and the respective time increment. In some examples, method 200 can further include evaluating at least one physical parameter, of the algorithm, between successive evaluations of the first subset of the nodes.

As a result of method 200, and in particular nodes 204-218, different nodes of a mesh can be time-evolved using different algorithms, which can be advantageous in some examples.

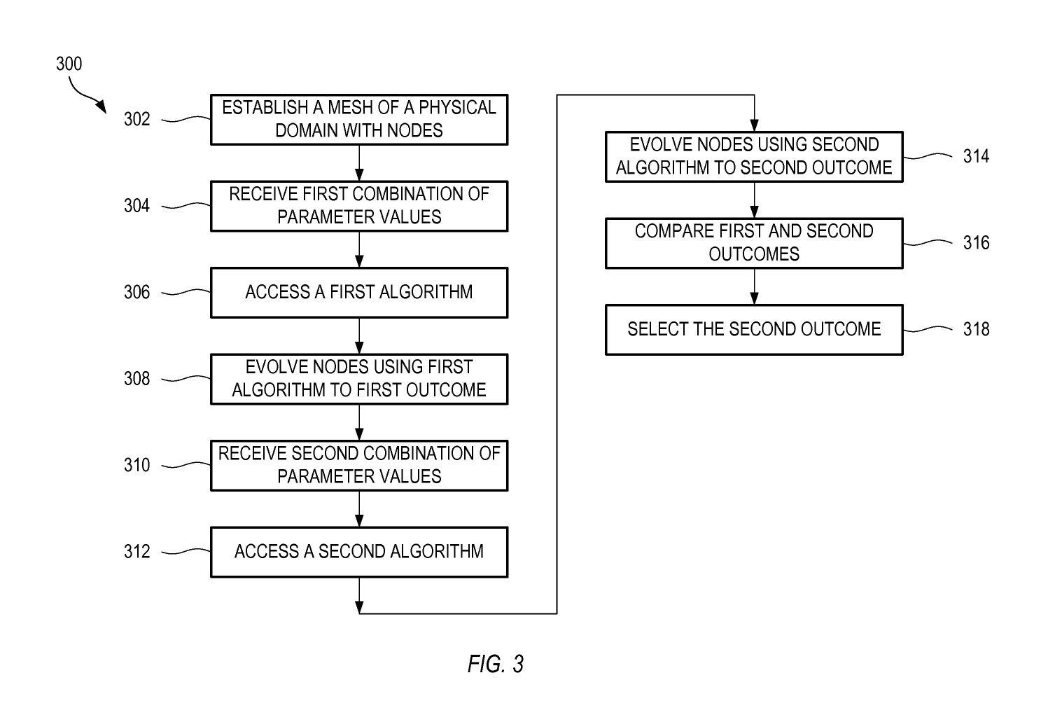

FIG. 3 is a flow chart showing another example of a computer-implemented method 300 for performing simulation. Such a method is capable of time-evolving nodes of a mesh using a first algorithm, sensing that the first algorithm has failed to converge, switching to a second algorithm, and time-evolving the nodes of the mesh using the second algorithm. The computer-implemented method of FIG. 3 is but one example; other examples can also be used.

At 302, method 300 establishes a mesh of a physical domain with nodes. The nodes represent a discretized physical quantity.

At 304, method 300 receives a first combination of parameter values. The parameter values can be input from a user, read from a stored file, or determined dynamically by an algorithm or a processor running the algorithm. In some examples, the parameter values include values that control a dissipation, a dispersion, and an overshoot for a particular algorithm. In some examples, the parameter values include values for ρₘₐₓ, ρₘᵢₙ, and ρₛₚᵤᵣᵢₒᵤₛ, where the values of ρₘₐₓ, ρₘᵢₙ, and ρₛₚᵤᵣᵢₒᵤₛ control the dissipation, the dispersion, and the overshoot for the particular algorithm. In some examples, the parameter values further include values that control whether a particular algorithm is implicit or explicit. In some examples the parameter values include values for η₁, η₂, and η₃, where the values of η₁, η₂, η₃ control whether the particular algorithm is a first-order algorithm or second-order algorithm. In some examples, each algorithm can be identified as a unique combination of values of ρₘₐₓ, ρₘᵢₙ, ρₛₚᵤᵣᵢₒᵤₛ, η₁, η₂, and η₃. The Appendix describes in detail how to determine values of ρₘₐₓ, ρₘᵢₙ, ρₛₚᵤᵣᵢₒᵤₛ, η₁, η₂, and η₃ for a given algorithm.

At 306, method 300 accesses a first algorithm for the first combination of parameter values, for evolving the nodes through sequential time steps.

At 308, method 300 evolves the nodes using the first algorithm, to generate a first outcome. In some examples, the first outcome is a determination that the first algorithm did not converge to a solution. Other first outcomes are also possible.

At 310, method 300 receives a second combination of parameter values, different from the first combination of parameter values. The parameter values can be input from a user, read from a stored file, or determined dynamically by an algorithm or a processor running the algorithm. The first and second combinations differ in at least one parameter value, and optionally, differ in more than one parameter value.

At 312, method 300 accesses a second algorithm, different from the first algorithm, for the second combination of parameter values, for evolving the nodes through sequential time steps.

At 314, method 300 evolves the nodes using the second algorithm, to generate a second outcome. In some examples, the second outcome is a determination that the second algorithm converged to a solution. Other second outcomes are also possible.

At 316, method 300 compares the first and second outcomes.

At 318, based on the comparing, method 300 selects the second outcome.

In some examples, the first algorithm can include at least one physical parameter. The first algorithm can be a function of the at least one physical parameter and the respective time increment. In some examples, method 300 can further include evaluating at least one physical parameter, of the algorithm, between successive evaluations of the nodes.

As a result, method 300 is capable of time-evolving nodes of a mesh using a first algorithm, sensing that the first algorithm has failed to converge, switching to a second algorithm, and time-evolving the nodes of the mesh using the second algorithm, which can be advantageous in some examples.

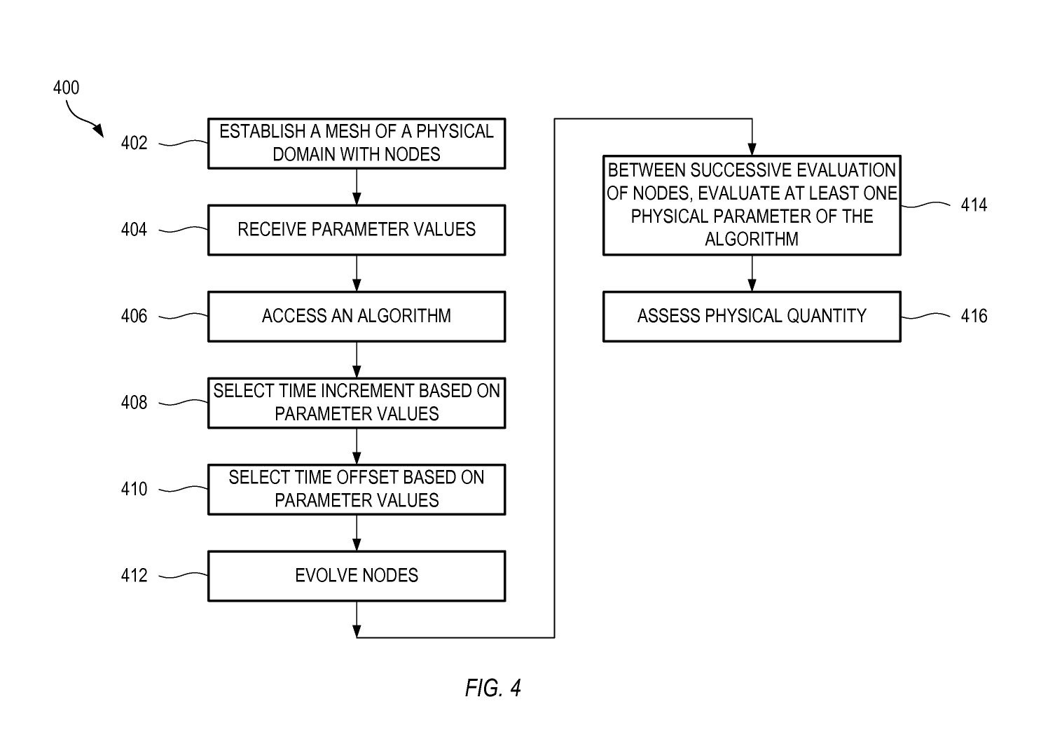

FIG. 4 is a flow chart showing another example of a computer-implemented method 400 for performing simulation. Such a method is capable of evaluating nodes and physical parameters in a staggered manner, with both being evaluated once per time increment, but the node evaluations being offset from the physical parameter evaluations. Such an offset can improve the satisfaction of the equation governing the simulation. The computer-implemented method of FIG. 4 is but one example; other examples can also be used.

At 402, method 400 establishes a mesh of a physical domain with nodes. The nodes represent a discretized physical quantity.

At 404, method 400 receives a combination of parameter values. The parameter values can be input from a user, read from a stored file, or determined dynamically by an algorithm or a processor running the algorithm. In some examples, the parameter values include values that control a dissipation, a dispersion, and an overshoot for the algorithm. In some examples, the parameter values include values for ρₘₐₓ, ρₘᵢₙ, and ρₛₚᵤᵣᵢₒᵤₛ, where the values of ρₘₐₓ, ρₘᵢₙ, and ρₛₚᵤᵣᵢₒᵤₛ control the dissipation, the dispersion, and the overshoot for the algorithm. In some examples, the parameter values further include values that control whether the algorithm is implicit or explicit. In some examples the parameter values include values for η₁, η₂, and η₃, where the values of η₁, η₂, and η₃ control whether the particular algorithm is implicit or explicit. In some examples, each algorithm can be identified as a unique combination of values of ρₘₐₓ, ρₘᵢₙ, ρₛₚᵤᵣᵢₒᵤₛ, η₁, η₂, and η₃. The Appendix describes in detail how to determine values of ρₘₐₓ, ρₘᵢₙ, ρₛₚᵤᵣᵢₒᵤₛ, η₁, η₂, and η₃ for a given algorithm.

At 406, method 400 accesses an algorithm for the combination of parameter values, for evolving the nodes through sequential time steps.

At 408, method 400 identifies a time increment for the combination of parameter values. The time increment can be input from a user, read from a stored file, or determined dynamically by the algorithm or a processor running the algorithm.

At 410, method 400 identifies a time offset based on the combination of parameter values. In some examples, the time offset is between zero and the time increment, inclusive. In some examples, the time offset is between zero and the time increment, exclusive.

At 412, method 400 evolves the nodes using the algorithm, from an initial time to a final time, using the time increment.

At 414, between successive evaluations of the nodes, method 400 evaluates at least one physical parameter of the algorithm. The evaluations of the at least one physical parameter can be delayed by the time offset with respect to the evaluations of the corresponding nodes. In some examples, the algorithm includes at least one physical parameter. The algorithm can be a function of the at least one physical parameter and the respective time increment. In other words, in some examples, the physical parameters are evaluated periodically, for each time increment, and the nodes are also evaluated periodically, for each time increment, but the times at which the physical parameters and the nodes are evaluated are offset or staggered with respect to one another. The time offset can be between zero and the respective time increment, inclusive or exclusive.

Each physical parameter can correspond to a term in an evolution equation in the algorithm. The evolution equation can be one of a linear time-varying differential equation, a non-linear time-varying differential equation, a first order differential equation, a second order differential equation, a linear differential algebraic equation, a non-linear differential algebraic equation, a first order differential algebraic equation, or a second order differential algebraic equation. The algorithm can use a numerical method that includes at least one of a finite element method, a finite difference method, a finite volume method, a meshless method, a meshfree method, a boundary element method, a spectral method, or a lattice Boltzmann method.

At 416, method 400 assesses the physical quantity based on the nodes at the final time.

As a result, method 400 is capable of evaluating nodes and physical parameters in a staggered manner, with both being evaluated once per time increment, but the node evaluations being offset from the physical parameter evaluations. Such an offset can improve the satisfaction of the equation governing the simulation. The computer-implemented method of FIG. 4 is but one example; other examples can also be used.

The remainder of this Detailed Description includes an Appendix that describes a simulation framework. The framework describes in detail how to relate a governing equation to a respective algorithm, how to classify algorithms that include a differential algebraic equation (DAE) or an ordinary differential equation (ODE) as first or second order, how to determine a combination of parameter values for a given algorithm, how to relate properties of second-order algorithms to those of first-order algorithms, and how to simplify a mathematical treatment of second-order algorithms by forcing the second-order algorithms into a simpler first-order mathematical treatment.

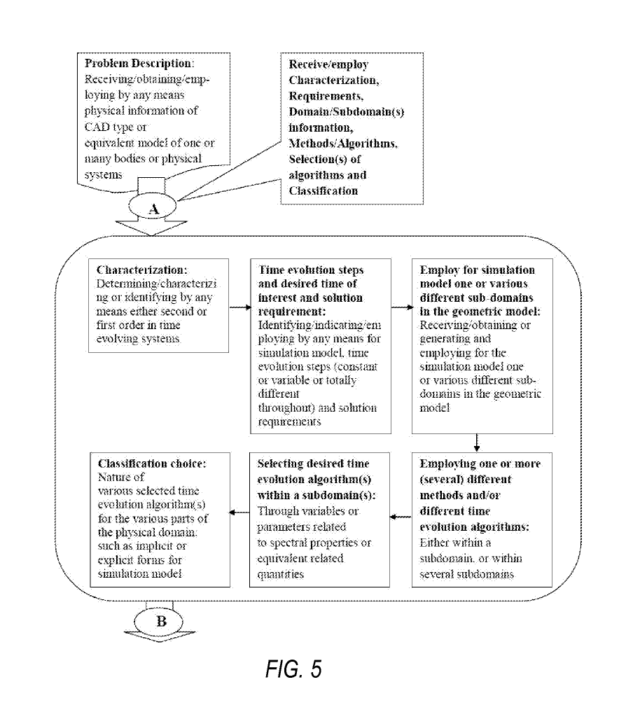

By using the framework described in the Appendix, and shown in FIGS. 5-21, one can achieve a number of advantages in performing computer-implemented simulation of a particular physical system. For instance, using the described framework can allow a user to time-evolve different nodes of a mesh using different time increments. As another example, using the described framework can allow a user to time-evolve different nodes of a mesh using different algorithms. As a further example, using the described framework can allow a user to sense that a calculation using the first algorithm has failed to converge, can automatically switch to a second algorithm, and can complete a calculation using the second algorithm. Other advantages are also possible.

### APPENDIX

This Appendix describes a framework for predicting or generating variables at future points in time for time evolving systems. The framework can evolve one or more primary variables, and can optionally derive one or more secondary variables through appropriate relationships or physical laws.

The framework can accommodate both linear and non-linear variables. The framework can be used accommodate first-order (with respect to a time variable) linear and nonlinear systems, and second-order (with respect to the time variable) linear and nonlinear systems. The framework evolves first order systems in a manner similar to second order systems, so that a user can switch between first and second order governing equations relatively easily. The framework can accommodate physical constraints and mechanical constraints. The framework can be introduced into new or existing time-evolution simulation software.

In one potential advantage, the framework can evolve nodes of a mesh, simultaneously using different algorithms for different subsets of mesh nodes. In another potential advantage, the framework can help ensure that the simulation uses physics consistently. In another potential advantage, the framework can help overcome numerical difficulties, such as lack of convergence. In another potential advantage, the framework can evolve nodes of a mesh using different time steps or increments for different subsets of mesh nodes. In another potential advantage, the framework can calculate one or more equation terms or coefficients, at suitable times during the simulation. In another potential advantage, the framework can treat first-order and second-order systems in a similar manner in software. In another potential advantage, the framework can simulate systems in a variety of engineering disciplines, such as mechanical, aerospace, biomedical, electrical, chemical, economic, and others. In another potential advantage, the framework can seamlessly incorporate simulation from different disciplines, such as fluids, structure, and thermal.

For a particular simulation, the framework establishes a mesh of a physical domain with nodes to discretize a physical quantity. The nodes can be spatial points within the framework. The mesh can accommodate finite element methods, finite volume methods, finite difference methods, boundary element methods, discrete element methods, spectral methods, lattice Boltzmann type methods, or other suitable structure. The framework can also use meshless or meshfree methods.

The framework accesses an algorithm to evolve the nodes, where the algorithm can include a governing equation. In some examples, the governing equation can be a partial differential equation, with a first-order or a second-order time dependence. In some examples, the framework can use physical constraints, mechanical constraints, and/or hidden constraints. The ordinary differential equation can be evolved in time.

The framework can include three free parameters, which describe the spectral properties of the simulated system, plus three other parameters. The six parameters can allow the framework to switch between implicit time evolution algorithms and explicit time evolution algorithms, each of which can be used to describe particular classes of physical systems. Alternatively, more or fewer than six parameters can be used.

The framework can treat each nonlinear term in a mathematical model separately. The framework can determine an algorithmic time evolution point, at which all computations are performed for each algorithm used in a simulation. The algorithmic time evolution point can determine a time level satisfaction. The algorithmic time evolution point and time level satisfaction can extend to both linear and non-linear evolving systems, for both differential algebraic equations and ordinary differential equations, both with and without constraints.

The framework can assign parameter values that relate to unique, discrete, numerically assigned markers (DNA) to the algorithms. Each algorithm can have its own, unique DNA. Furthermore, if two algorithms have the same assigned DNA, then the two algorithms are mathematically equivalent.

FIG. 5 is a flow chart showing an example of an initial portion of the framework for first order and second order time-evolving mathematical models.

The initial portion of the framework includes a problem description. In some examples, the problem description receives as input a model of the physical system. The model can include coordinates of physical bodies of interest, such as from a CAD drawing. For these examples, the framework generates a mesh from the model of the physical system. In other examples, the problem description receives the mesh from an external source. The output of the problem description can include a collection of spatial mesh points.

In addition, the problem description can receive, or specify, physical information related to the spatial mesh points.

For instance, for a system in the area of structural mechanics, solid mechanics, dynamics, multi-body dynamics, or contact-impact-penetration-damage mechanics, the physical information can include physical properties, boundary conditions, initial conditions, constitutive relations or laws or equivalent relations of the various materials physics and mechanics, constraints and information, physical properties related to mass, damping, stiffness, potentials, loads, forces and sources.

As another example, for a system in the area of heat transfer, or conservation of energy, the physical information can include capacitance, conduction, convection, radiation, internal heat-generating sources, and general boundary and initial conditions.

As another example, for a system in the area of fluid flow, the physical information can include geometry, model, conservation of momentum, gravity loads, pressure gradients, viscosity and conservation of mass related information, viscous forces and diffusion physics.

The initial portion of the framework includes a characterization. At the characterization, the framework identifies whether the simulated system is first-order in time, or is second-order in time, based on a particular set of conditions. Such an identification can be made by the framework, or received as input by the framework.

The initial portion of the framework includes a time evolution step. At the time evolution step, the framework identifies one or more time increments for the mesh nodes. Such an identification can be made by the framework, or received as input by the framework. The time increments can be the same for all the nodes, can differ for one or more nodes, or can differ for all the nodes.

The initial portion of the framework includes a sub-domain identification step. At the sub-domain identification step, the framework can optionally identify one or more subsets of nodes of the mesh. Such an identification can be made by the framework, or received as input by the framework. The subsets can optionally evolve independently of one another. In some examples, the sub-domain can simply return the full number of nodes, without identifying any subsets.

The initial portion of the framework includes an algorithm identification step. At the algorithm selection step, the framework identifies one or more algorithms to use in subsequent evolution steps. Each algorithm can have its own unique DNA.

The initial portion of the framework includes an algorithm selection step. At the algorithm selection step, the framework selects which of the identified algorithms to use for the selected time increments and the selected subsets of nodes. Such an identification can be made by the framework, or received as input by the framework.

The initial portion of the framework includes a classification choice. At the classification choice, the framework identifies whether a selected algorithm is implicit or explicit, for each of the selected algorithms, selected subsets of nodes, and selected time increments. Such an identification can be made by the framework, or received as input by the framework.

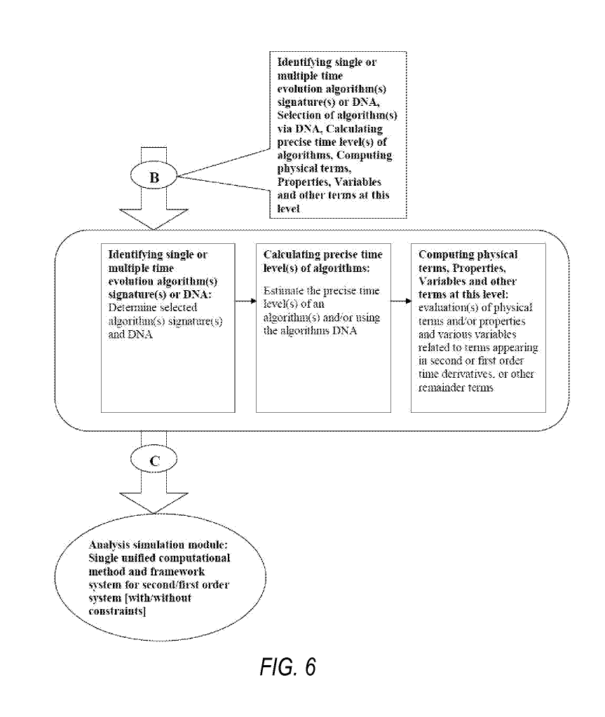

FIG. 6 is a flow chart showing an example of a further portion of the framework for first order and second order time-evolving mathematical models.

The further portion of the framework includes a DNA identification step. At the DNA identification step, the framework receives a unique combination of parameter values for each algorithm to be used. The parameters can control a dissipation, a dispersion, and an overshoot for a particular algorithm, as well as whether a particular algorithm is implicit or explicit, based on the initial conditions. Such a specification can be made by the framework, or received as input by the framework.

The further portion of the framework includes a time level determination step. At the time level determination step, the framework identifies the time increments for the algorithm or algorithms to be used in the simulation, for the selected nodes or selected subsets of nodes. Such a determination can be made by the framework, or received as input by the framework.

The further portion of the framework includes a physical term computing step. At the physical term computing step, the framework calculates physical quantities related to the algorithms, such as internal forces, external forces, constraint forces, normalized time weighted residual computations, and so forth. Such a calculation can be performed by the framework, or received as input by the framework.

The further portion of the framework includes a computation step. At the preliminary computation step, the evolution is actually performed. During the evolution, the framework can switch from one algorithm to another, can use different algorithms for different mesh nodes, can switch from one time increment to another, and/or can use different time increments for different mesh nodes.

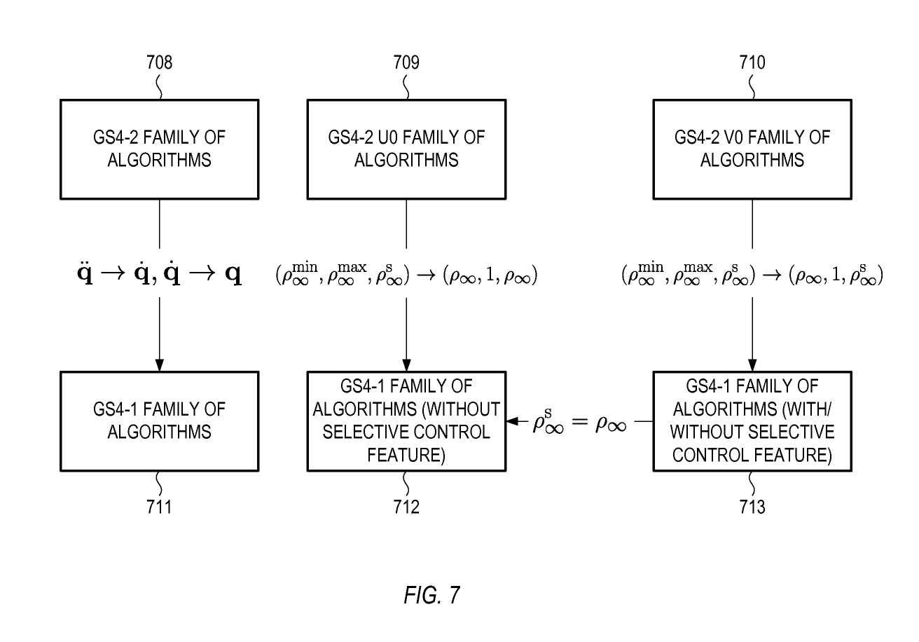

FIG. 7 is a flow chart showing an example of adapting a second order time-evolving mathematical model to a first order time-evolving mathematical model. The families of algorithms discussed herein are referred to as generalized single step single solve algorithms (GS4).

Second-order algorithms, which can include a differential equation having a second derivative with respect to time, are denoted as GS4-2. Second-order algorithms can apply to systems such as hyperbolic heat conduction, elastodynamics, rigid/flexible multi-body dynamics, and crashworthiness and wave propagation, contact-impact, and others. Any linear second-order dynamic algorithm or family of algorithms can be cast within the GS4-2 framework.

The GS4-2 framework can optionally control zero-order displacement overshoot and zero-order velocity overshoot for numerical dissipative algorithms. The GS4-2 framework can optionally limit numerical dissipation and numerical dispersion for damped dynamic systems. The GS4-2 framework can optionally conserve energy and momentum for undamped dynamic systems. The GS4-2 framework can use a normalized time-weighted residual approach. The GS4-2 framework can conserve energy, linear momentum, and angular momentum for nonlinear second order dynamic systems with and/or without constraints, and can do so without enforcing energy constraints.

First-order algorithms, which can include a differential equation having a first derivative with respect to time, are denoted as GS4-1. First-order algorithms can apply to systems such as parabolic heat conduction, first order hyperbolic systems such as fluid flow, electromagnetics, and others.

The GS4-1 framework can optionally suppress numerical oscillations associated with a primary variable and its time derivative. The GS4-1 framework can selectively control aspects of the simulation, in order to produce a representative solution that correctly capture the dynamics of the system.

By setting particular parameters appropriately, as shown in FIG. 7, the framework can reduce second-order algorithms to first-order algorithms. In general, by simulating a physical system using the second-order algorithms, the framework can optionally set the particular parameters appropriately, and can optionally use first-order algorithms in the same mesh and the same simulation as second-order algorithms. Historically, mixing or switching smoothly between first- and second-order algorithms has been difficult or cumbersome. The framework can accommodate, and switch among, first-order transient systems, first-order dynamic systems, second-order transient systems, second-order dynamic systems, implicit algorithms, and explicit algorithms.

By replacing a second time derivative of a quantity with a first time derivative of the quantity, and replacing a first time derivative of the quantity with the quantity, as follows,

\ddot{q}→\dot{q},\dot{q}→q,

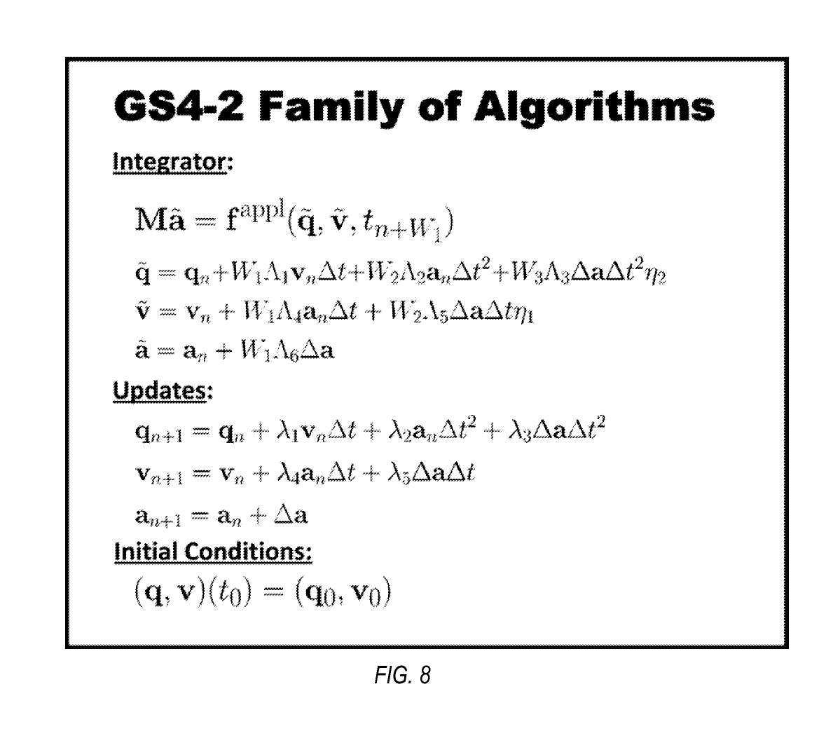

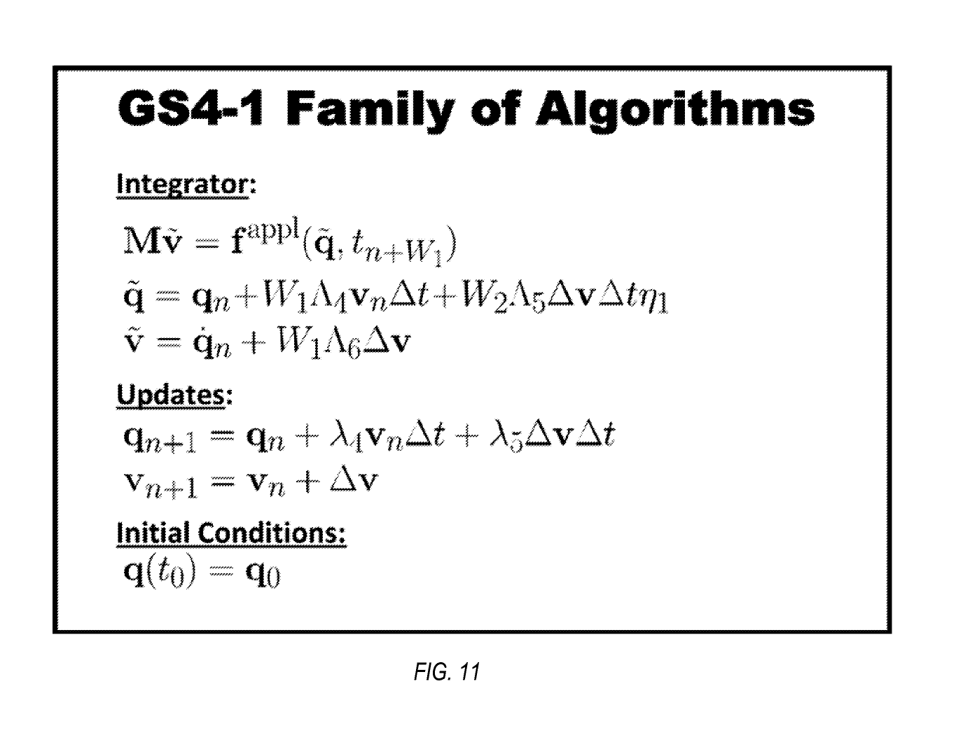

the framework can reduce a GS4-2 family of algorithms 708 (see FIG. 8) to a GS4-1 family of algorithms 711 (see FIG. 11).

Parameter ρ_{∞}^{max} is a maximum principal root or spectral radius at a high-frequency range. Parameter ρ_{∞}^{min} is a minimum principal root at the high-frequency range. Parameter ρ_{∞}^{s} is a spurious root at the high-frequency range. Zero is less than or equal to ρ_{∞}^{s}, which is less than or equal to ρ_{∞}^{min}, which is less than or equal to ρ_{∞}^{max}, which is less than or equal to one.

By replacing three parameters as follows,

(ρ_{∞}^{min}, ρ_{∞}^{max}, ρ_{∞}^{s})→(ρ_{∞}, 1, ρ_{∞}),

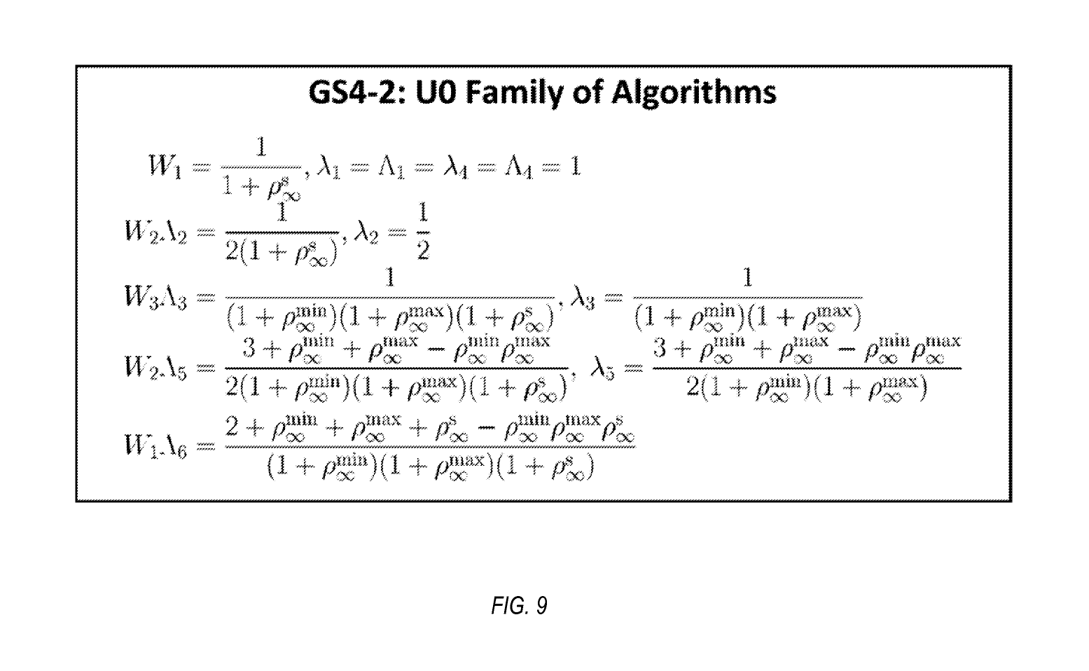

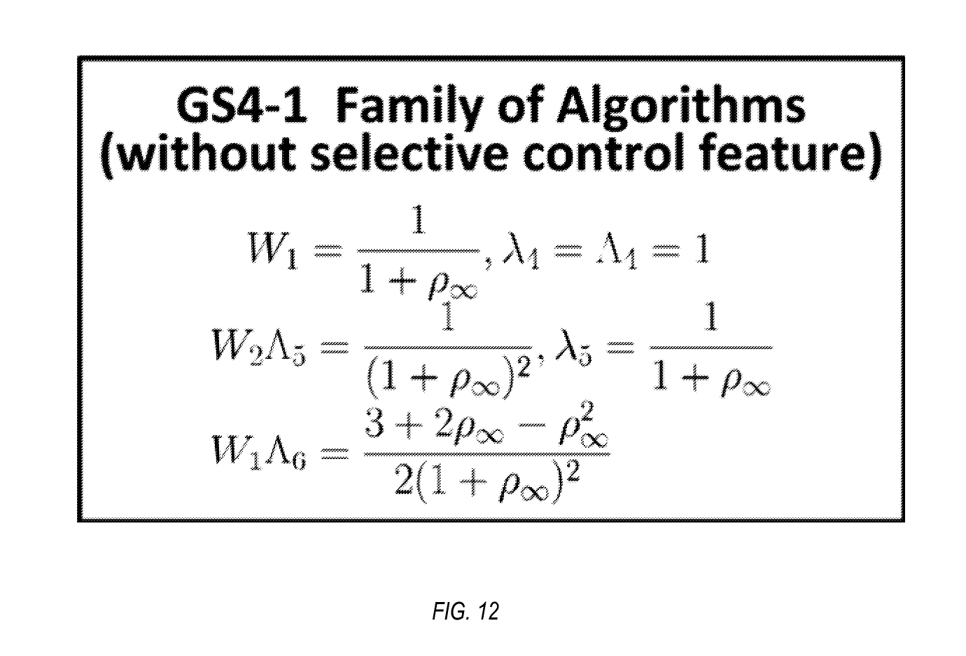

the framework can reduce a GS4-2 U0 family of algorithms 709 (see FIG. 9) to a GS4-1 family of algorithms (without selective control feature) 712 (see FIG. 12).

By replacing three parameters as follows,

(ρ_{∞}^{min}, ρ_{∞}^{max}, ρ_{∞}^{s})→(ρ_{∞}, 1, ρ_{∞}^{s})

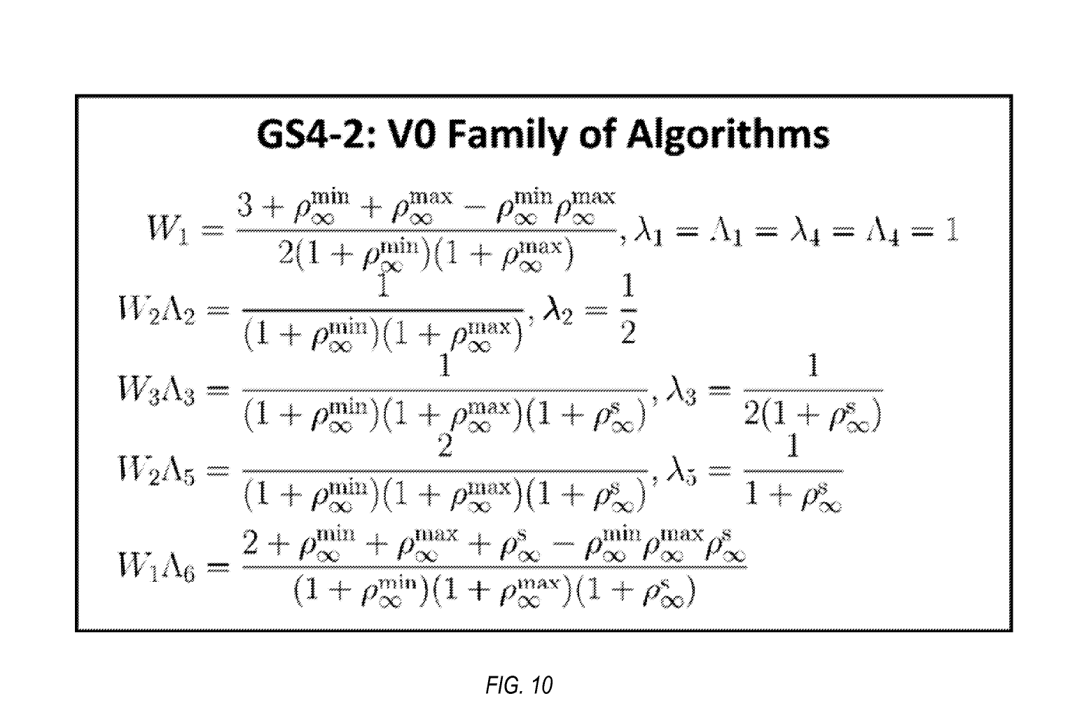

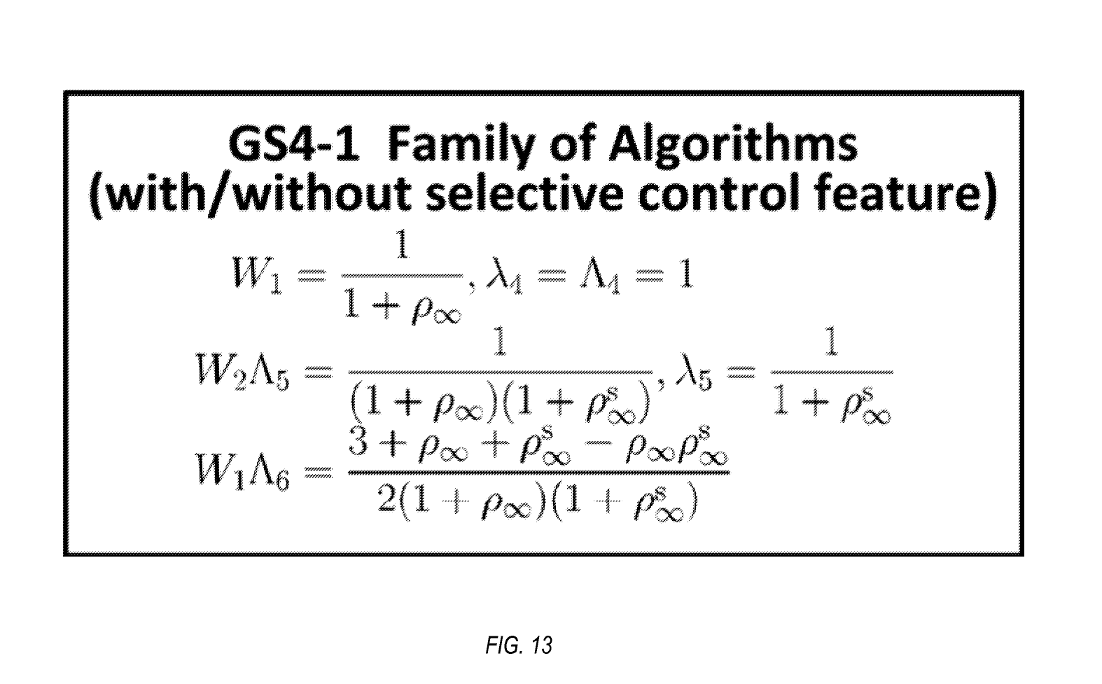

the framework can reduce a GS4-2 V0 family of algorithms 710 (see FIG. 10) to a GS4-1 family of algorithms (with/without selective control feature) 713 (see FIG. 13). By further replacing the following parameter,

P_{∞}^{s}=P_{∞},

the framework can reduce the GS4-1 family of algorithms (with/without selective control feature) 713 (see FIG. 13) to the GS4-1 family of algorithms (without selective control feature) 712 (see FIG. 12).

Parameters η₁, η₂, and η₃ can vary between zero and one, inclusive. The framework can use various combinations of η₁, η₂, and η₃ to control which family of algorithms to use. For example, when η₁=1 and η₂=1, the framework uses the U0 and V0 families of algorithms 708, 709. As another example, when η₁=1 and η₂=0, the framework uses an explicit physical treatment of a velocity term. As another example, when η₂=0 and η₃=0, the framework uses a central difference method. Other examples are possible, as well.

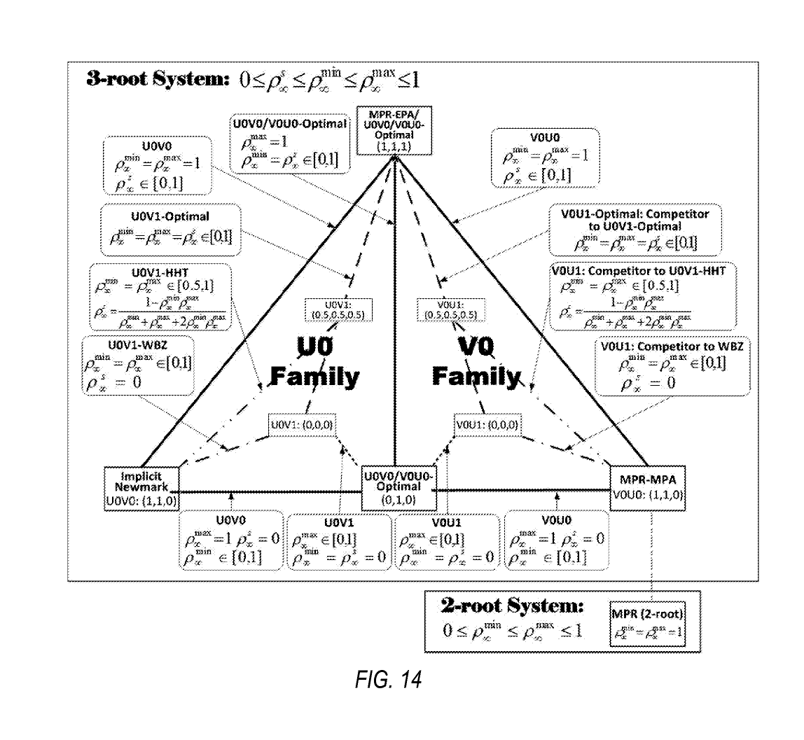

FIG. 14 shows examples of relationships between the U0 and V0 families of algorithms, for second order systems, from the example of FIG. 7.

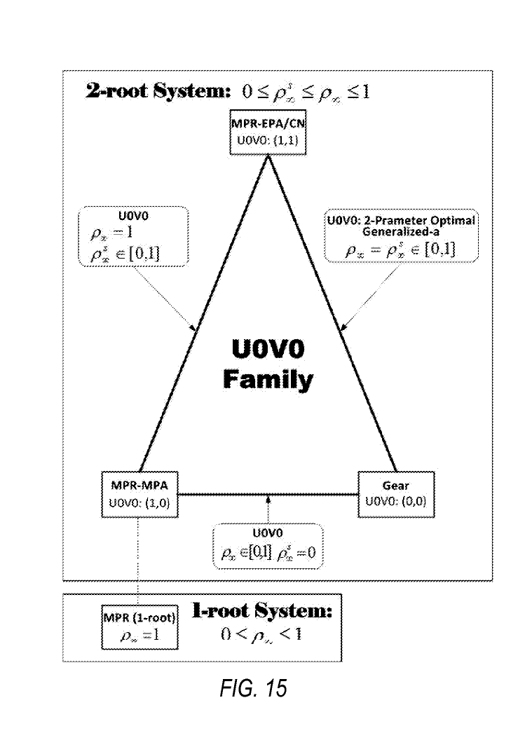

FIG. 15 shows details of the U0V0 family of algorithms, for first order systems, from the example of FIG. 7.

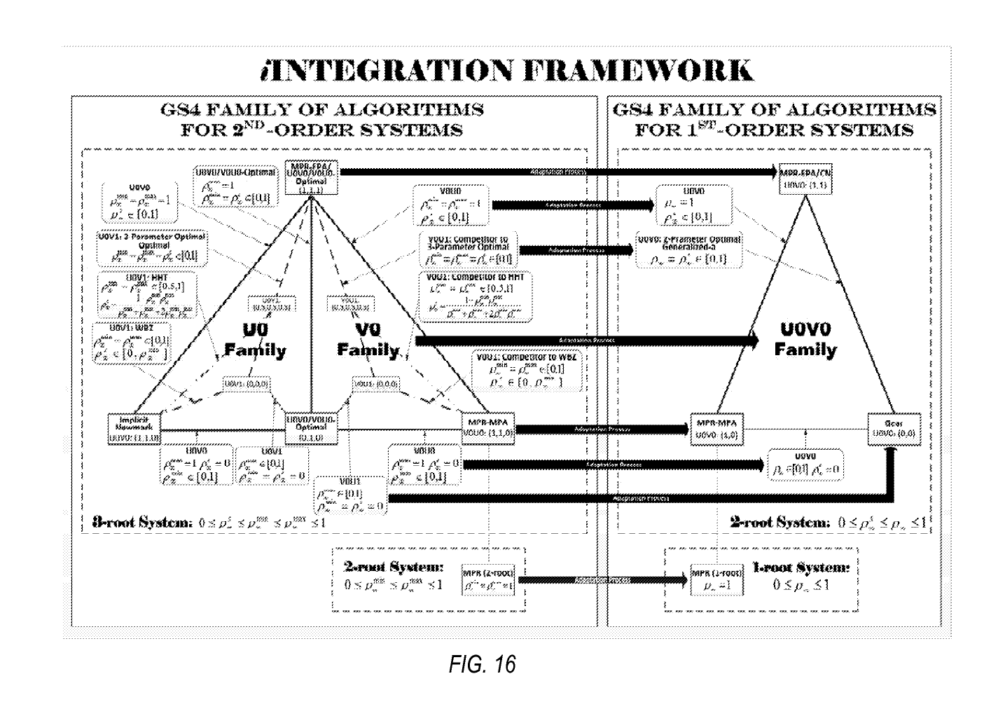

FIG. 16 shows examples of relationships among the U0, V0, and U0V0 families of algorithms, for second order systems and first order systems, from the example of FIG. 7.

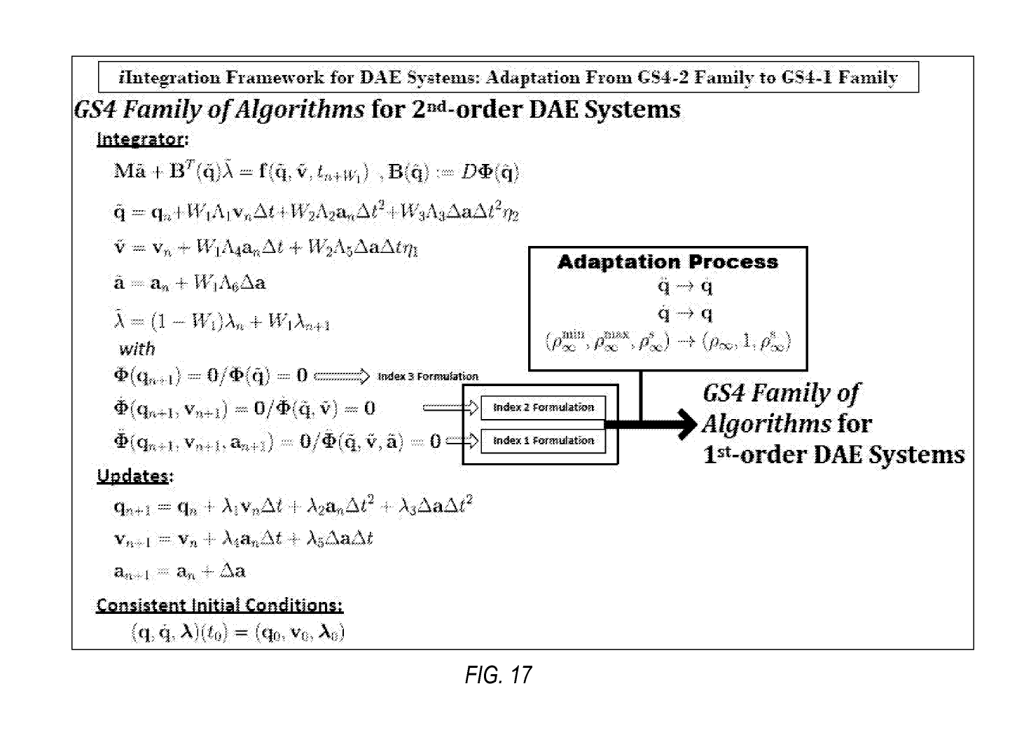

FIG. 17 shows details of the GS4 family of algorithms, for second-order differential algebraic equations (DAEs), and adaptable to first order DAEs.

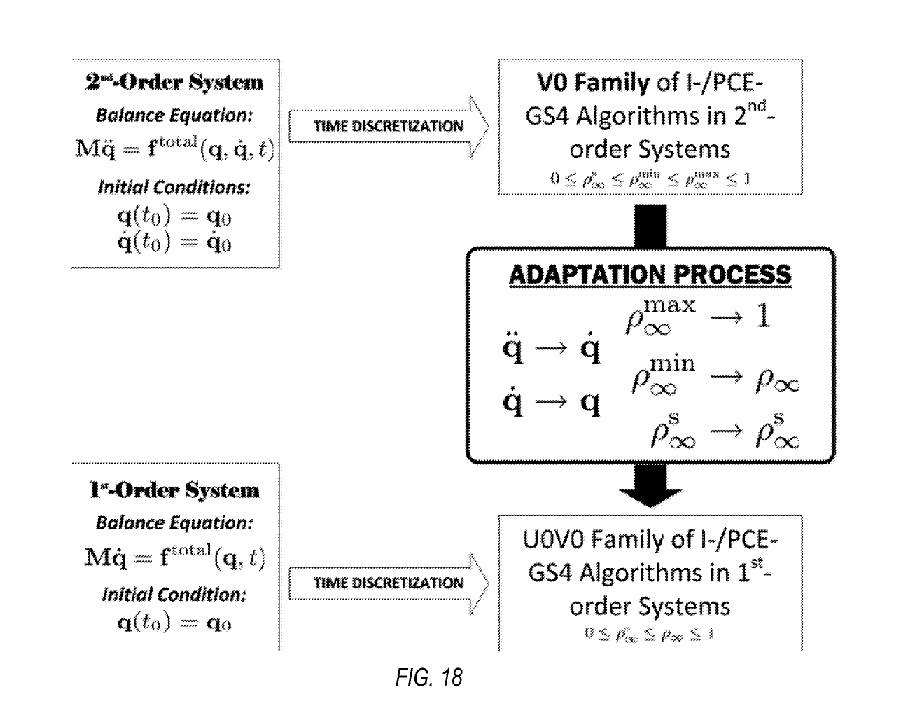

FIG. 18 is a flow chart showing another example of adapting a second order time-evolving mathematical model to a first order time-evolving mathematical model.

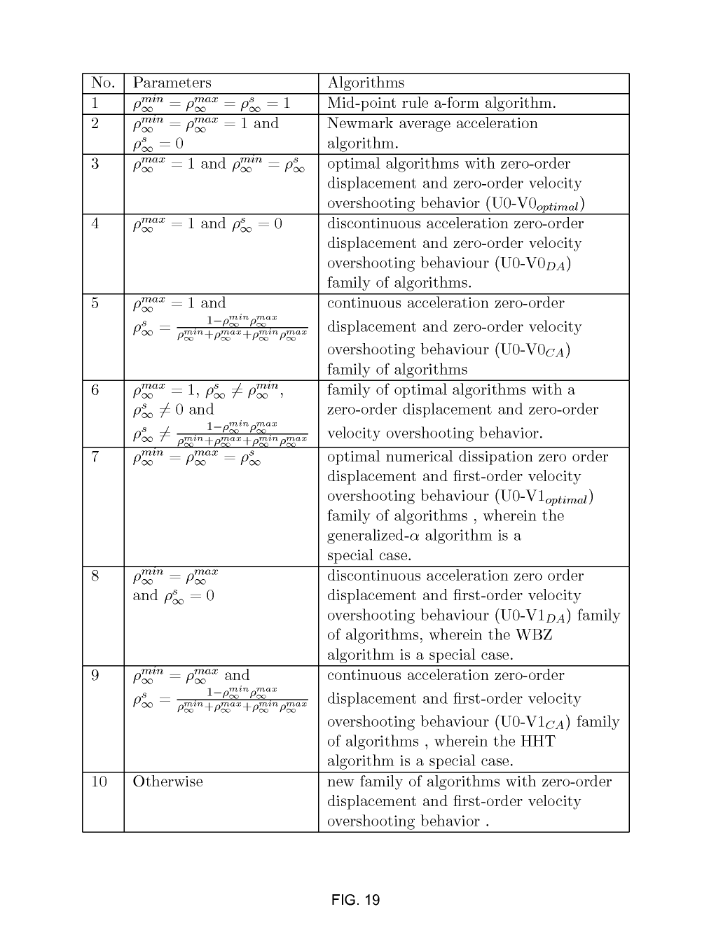

FIG. 19 is a table of algorithms from the GS4-2 U0 family of algorithms.

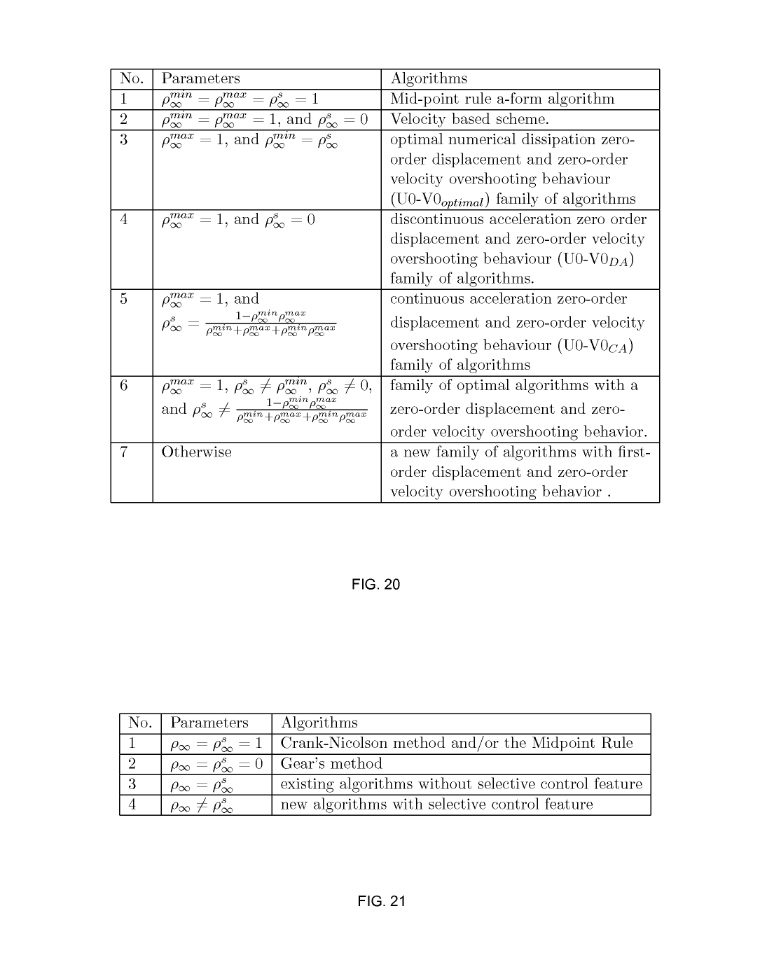

FIG. 20 is a table of algorithms from the GS4-2 V0 family of algorithms

FIG. 21 is a table of algorithms from the GS4-1 family of algorithms.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A computer-implemented method for performing simulation, comprising:
establishing a mesh of a physical domain with nodes, the nodes representing a discretized physical quantity;
receiving a combination of parameter values;
accessing an algorithm for the combination of parameter values, for evolving the nodes through sequential time steps;
identifying a first time increment for the combination of parameter values;
selecting a first subset of the nodes for the combination of parameter values;
evolving the first subset of the nodes using the algorithm, from an initial time to a final time, using the first time increment;
identifying a second time increment, different from the first time increment, for the combination of parameter values;
selecting a second subset of the nodes, different from the first subset, for the combination of parameter values;
evolving the second subset of the nodes using the algorithm, from the initial time to the final time, using the second time increment; and
assessing the physical quantity based on the first subset of the nodes from the initial time to the final time and the second subset of the nodes from the initial time to the final time.

2. The computer-implemented method of claim 1,
wherein the parameter values include values for ρₘₐₓ, ρₘᵢₙ, and ρₛₚᵤᵣᵢₒᵤₛ; and
wherein the values of ρₘₐₓ, ρₘᵢₙ, and ρₛₚᵤᵣᵢₒᵤₛ control a dissipation, a dispersion, and an overshoot for a particular algorithm.

3. The computer-implemented method of claim 1,
wherein the parameter values include values for η₁, η₂, and η₃; and
wherein the values of η₁, η₂, and η₃ control whether a particular algorithm is implicit or explicit.

4. The computer-implemented method of claim 1,
wherein the algorithm includes at least one physical parameter; and further comprising:
determining a first time offset based on the combination of parameter values, the first time offset being between zero and the first time increment, inclusive; and
evaluating at least one physical parameter, of the algorithm, between successive evaluations of the first subset of the nodes, wherein the evaluation of the at least one physical parameter and the evaluation of the corresponding node are offset by the first time offset.

5. A computer-implemented method for performing simulation, comprising:
establishing a mesh of a physical domain with nodes, the nodes representing a discretized physical quantity;
receiving a first combination of parameter values;
accessing a first algorithm for the first combination of parameter values, for evolving the nodes through sequential time steps;
receiving a second combination of parameter values, different from the first combination of parameter values;
accessing a second algorithm, different from the first algorithm, for the second combination of parameter values, for evolving the nodes through sequential time steps;
selecting a first subset of the nodes for the first and second combinations of parameter values;
evolving the first subset of the nodes using the first algorithm, from an initial time to a final time;
selecting a second subset of the nodes, different from the first subset, for the first and second combinations of parameter values;
evolving the second subset of the nodes using the second algorithm, from the initial time to the final time; and
assessing the physical quantity based on the first subset of the nodes from the initial time to the final time and the second subset of the nodes from the initial time to the final time.

6. The computer-implemented method of claim 5,
wherein the parameter values include values for ρₘₐₓ, ρₘᵢₙ, and ρₛₚᵤᵣᵢₒᵤₛ; and
wherein the values of ρₘₐₓ, ρₘᵢₙ, and ρₛₚᵤᵣᵢₒᵤₛ control a dissipation, a dispersion, and an overshoot for a particular algorithm.

7. The computer-implemented method of claim 5,
wherein the parameter values include values for η₁, η₂, and η₃; and
wherein the values of η₁, η₂, and η₃ control whether a particular algorithm is implicit or explicit.

8. The computer-implemented method of claim 5,
wherein the first algorithm includes at least one physical parameter; and further comprising:
evaluating at least one physical parameter, of the algorithm, between successive evaluations of the first subset of the nodes.

9. A computer-implemented method for performing simulation, comprising:
establishing a mesh of a physical domain with nodes, the nodes representing a discretized physical quantity;
receiving a first combination of parameter values;
accessing a first algorithm for the first combination of parameter values, for evolving the nodes through sequential time steps;
evolving the nodes, using the first algorithm, to generate a first outcome;
receiving a second combination of parameter values, different from the first combination of parameter values;
accessing a second algorithm, different from the first algorithm, for the second combination of parameter values, for evolving the nodes through sequential time steps;
evolving the nodes, using the second algorithm, to generate a second outcome;
comparing the first and second outcomes; and
based on the comparing, selecting the second outcome.

10. The computer-implemented method of claim 9,
wherein the first outcome is a determination that the first algorithm did not converge to a solution; and
wherein the second outcome is a determination that the second algorithm converged to a solution.

11. The computer-implemented method of claim 9,
wherein the parameter values include values for ρₘₐₓ, ρₘᵢₙ, and ρₛₚᵤᵣᵢₒᵤₛ; and
wherein the values of ρₘₐₓ, ρₘᵢₙ, and ρₛₚᵤᵣᵢₒᵤₛ control a dissipation, a dispersion, and an overshoot for a particular algorithm.

12. The computer-implemented method of claim 9,
wherein the parameter values include values for η₁, η₂, and η₃; and
wherein the values of η₁, η₂, and η₃ control whether a particular algorithm is implicit or explicit.

13. The computer-implemented method of claim 9,
wherein the first algorithm includes at least one physical parameter; and further comprising:
evaluating at least one physical parameter, of the algorithm, between successive evaluations of the nodes.

14. A computer-implemented method for performing simulation, comprising:
establishing a mesh of a physical domain with nodes, the nodes representing a discretized physical quantity;
receiving a combination of parameter values;
accessing an algorithm for the combination of parameter values, for evolving the nodes through sequential time steps;
identifying a time increment for the combination of parameter values;
identifying a time offset based on the combination of parameter values, the time offset being between zero and the time increment, inclusive;
evolving the nodes using the algorithm, from an initial time to a final time, using the time increment;
between successive evaluations of the nodes, evaluating at least one physical parameter of the algorithm, wherein the evaluations of the at least one physical parameter are delayed by the time offset with respect to the evaluations of the corresponding nodes; and
assessing the physical quantity based on the nodes from the initial time to the final time.

15. The computer-implemented method of claim 14, wherein the time offset is between zero and the time increment, exclusive.

16. The computer-implemented method of claim 14, wherein the algorithm is a function of the at least one physical parameter and the time increment.

17. The computer-implemented method of claim 14, wherein each physical parameter corresponds to a term in an evolution equation in the algorithm.

18. The computer-implemented method of claim 17, wherein the evolution equation is one of a linear time-varying differential equation, a non-linear time-varying differential equation, a first order differential equation, a second order differential equation, a linear differential algebraic equation, a non-linear differential algebraic equation, a first order differential algebraic equation, or a second order differential algebraic equation.

19. The computer-implemented method of claim 17, wherein the algorithm uses a numerical method that includes at least one of a finite element method, a finite difference method, a finite volume method, a meshless method, a meshfree method, a boundary element method, a spectral method, or a lattice Boltzmann method.

20. The computer-implemented method of claim 14,
wherein the parameter values include values for ρₘₐₓ, ρₘᵢₙ, and ρₛₚᵤᵣᵢₒᵤₛ;
wherein the values of ρₘₐₓ, ρₘᵢₙ, and ρₛₚᵤᵣᵢₒᵤₛ control a dissipation, a dispersion, and an overshoot for the algorithm;
wherein the parameter values further include values for η₁, η₂, and η₃; and
wherein the values of η₁, η₂, and η₃ control whether the algorithm is implicit or explicit.
